(19) United States
(12) Patent Application Publication
(10) Pub. No.: US 2009/0256769 A1
(43) Pub. Date: Oct. 15, 2009

(54) ASYMMETRICAL YAGI REPRESENTATION OF DIPOLE UWB ANTENNA

(75) Inventors: CHING-NENG KAN, Taoyuan County (TW); HSUAN-YI KUO, Taoyuan County (TW)

Correspondence Address: WPAT, PC, 7225 BEVERLY ST., ANNANDALE, VA, 22003, US

(73) Assignee: KINSUN INDUSTRIES INC., Taoyuan County (TW)

(21) Appl. No.: 12/100,022

(22) Filed: Apr. 9, 2008

(51) Int. Cl. H01Q 19/30

(52) U.S. Cl. 343/819

(57) ABSTRACT

The present invention related an asymmetrical yagi representation of dipole UWB antenna herein, said antenna located on a substrate and able to be interconnected to a wireless communication apparatus. The antenna comprising: a first radiation arm, said radiation arm comprising a first feed point, a first branch, a second branch, and a first tail. The second radiation arm comprising a second feed point, a third branch, a fourth branch and a second tail. Said first tail and said second tail point are located at the farthest spot from the first radiation arm and the second radiation arm respectively.

### BACKGROUND OF THE INVENTION

1. Field of the Invention

The present invention related to an asymmetrical yagi representation of dipole UWB antenna, more particularly, to an asymmetrical yagi representation of dipole UWB antenna mounted on a substrate, said antenna comprises a first radiation arm and a second radiation arm, and the width and the length of said first radiation arm and said second radiation arm are designed according to frequency response match demand.

2. Description of the Related Art

As the modern communication technology gets ahead, wireless communication devices are largely used in notebooks, cellular phones and PDA to serve the wireless communication purposes. In general, wireless communication devices will use built-in antenna due to their prettier outlooks. However; the popular built-in antenna sacrificed its bandwidth and radiation efficiency in order to benefit from its size shrink, said antenna is of bad characteristics and uneasy to adjust to the certain frequency response for the corresponding electronic products, or its bandwidth range is very small. The present invention is a solution of antenna structure to overcome the above problems.

### SUMMARY OF THE INVENTION

The following description of various embodiments of antenna designs and methods is not to be construed in any way as limiting the subject matter of the appended claims. The major purpose for the present invention is to build an asymmetrical yagi representation of dipole UWB antenna mounted on a substrate, and said antenna comprises a first radiation arm and a second radiation arm. Through the calculation of the length and width of the first radiation arm and the second radiation arm, the frequency response can be adjusted according to the match demand.

Another purpose for the present invention is to easily and simply mass production and improving the yield by the structure setting on the substrate.

Yet another purpose for the present invention is to increase radiation surfaces according to the actual demand thus the asymmetrical yagi representation of dipole UWB antenna can receive and transmit electromagnetic wave at different frequencies.

In order to achieve the goals mentioned above, the present invention related to an asymmetrical yagi representation of dipole UWB antenna, mounted on a substrate and attachable to a wireless communication apparatus, which comprises a first radiation arm, said first radiation arm comprising a first feed point, a first branch, a second branch, and a first tail; and a second radiation arm, said second radiation arm comprising a second feed point, a third branch, a fourth branch, and a second tail; said first feed point and said second feed point are interconnected to a wireless communication apparatus, said first tail and said second tail are located at the farthest spot from the first radiation arm and the second radiation arm respectively.

Preferably, the substrate is selected from one of a PCB or a metal radiation slice. Also, said first branch, said second branch, said third branch, said fourth branch and said first tail and said second tail are measured as λ/4, λ is a wavelength corresponding to different frequencies for the UWB antenna.

### BRIEF DESCRIPTION OF THE DRAWINGS

Other objectives and advantages of the invention will become apparent upon reading the following detailed description and upon reference to the accompanying drawings in which:

FIG. 1 is the first embodiment of the asymmetrical yagi representation of dipole UWB antenna according to the present invention;

FIG. 2 is a frequency response plot of FIG. 1;

FIG. 3 is the second embodiment of the asymmetrical yagi representation of dipole UWB antenna according to the present invention;

FIG. 4 is a frequency response plot of FIG. 3;

FIG. 5 is the third embodiment of the asymmetrical yagi representation of dipole UWB antenna according to the present invention.

FIG. 6 is the fifth embodiment of the asymmetrical yagi representation of dipole UWB antenna according to the present invention.

FIG. 7 is the sixth embodiment of the asymmetrical yagi representation of the dipole UWB antenna according to the present invention.

FIG. 8 is the seventh embodiment of the asymmetrical yagi representation of dipole UWB antenna according to the present invention.

FIG. 9 is the eighth embodiment of the asymmetrical yagi representation of dipole UWB antenna according to the present invention.

FIG. 10A is the ninth embodiment of the asymmetrical yagi representation of dipole UWB antenna according to the present invention.

FIG. 10B is the tenth embodiment of the asymmetrical yagi representation of dipole UWB antenna according to the present invention.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF PREFERRED EMBODIMENTS

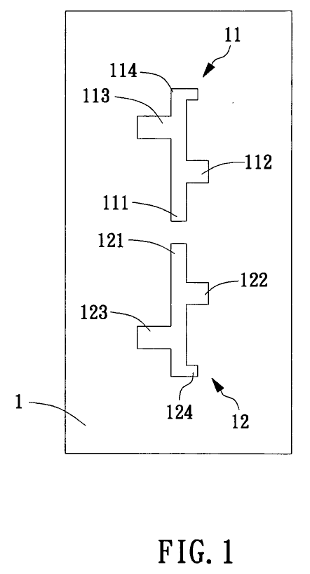

Turning now to the drawings, FIG. 1 illustrates a first embodiment of the symmetrical matrix representation of dipole UWB antenna. It is attachable to wireless communication apparatus, and the symmetrical matrix representation of dipole UWB antenna is mounted on a substrate 1, said substrate 1 is selected from a PCB and metal radiation slice therefore its manufacturing cost is lower than conventional cylinder antenna or spiral antenna. Meanwhile, it is thinner, lighter, shorter, and smaller than prior-art antenna. Said antenna comprises: A first radiation arm 11, 11 comprises a first feed port 111, a first branch 112, a second branch 113 and a first tail 114; a second radiation arm 12, said arm 12 comprises a second feed port 121, a third branch 122, a fourth branch 123 and a second tail 124. Said 111 and said 121 are used to interconnect to wireless communication apparatus (For instance, notebook, cellular phone or PDA, which is not illustrated in the drawings). Said first feed point 111 and said second feed point 121 are located at the nearest spot from the first radiation arm 11 and the second radiation arm 12 respectively; and said first tail 114 and said second tail 124 are located at the farthest spot from the first radiation arm and the second radiation arm respectively.

In the first radiation arm 11, at the right side of the conterminous line of said feed point 111 it raises the first branch 112. Above 112, at the left side of said conterminous line of said feed point 111 it further raises a second branch 113. Above 113, at the right side of said conterminous line of said feed point 111 it further raises a first tail 114. And then the first radiation arm is formed.

Similarly, in the second radiation arm 12, at the right side of the conterminous line of said feed point 121 it raises the third branch 122. Below 122, at the left side of said conterminous line of said feed point 121 it further raises a fourth branch 123. Below 123, at the right side of said conterminous line of said feed point 121 it further raises a second tail 124. And then the second radiation arm is formed.

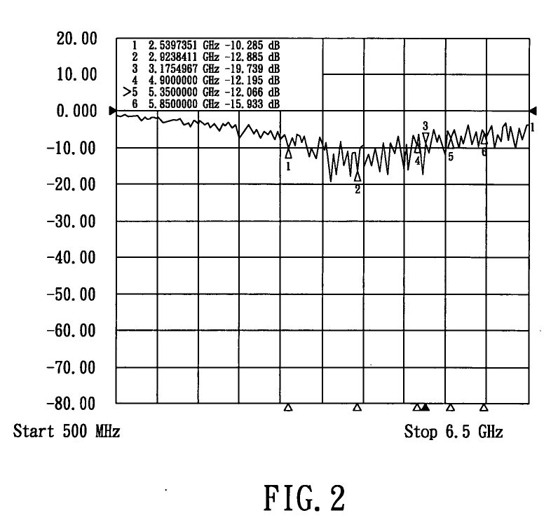

As suggested by FIG. 2, it related to the antenna frequency response linear plot of FIG. 1., wherein the antenna illustrated in FIG. 1 shows the minimum of the antenna frequency horizontal (x) axis is 500 MHz, and the maximum is 6.5 GHz. Its vertical (y) axis, related to reflection loss (dB). Skilled person in the art can understand, according to the plot of FIG. 2, within the range of ultra wide band (500 MHz˜6.5 GHz) the antenna frequency response can keep a steady frequency response value. Mainly, the first branch 112, the second branch 113 and the first tail 114 of the first radiation arm 11 as well as the third branch 122, the fourth branch 123, and the second tail 124 of the second radiation arm 12 were constituted a UWB antenna at λ (wavelength)/4 according to different frequencies.

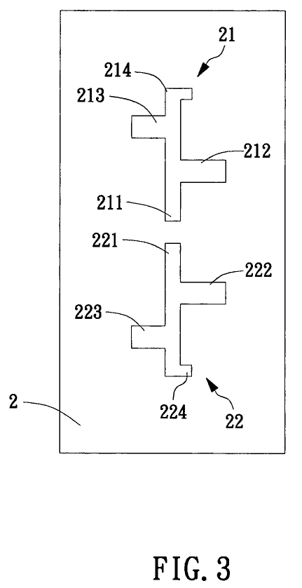

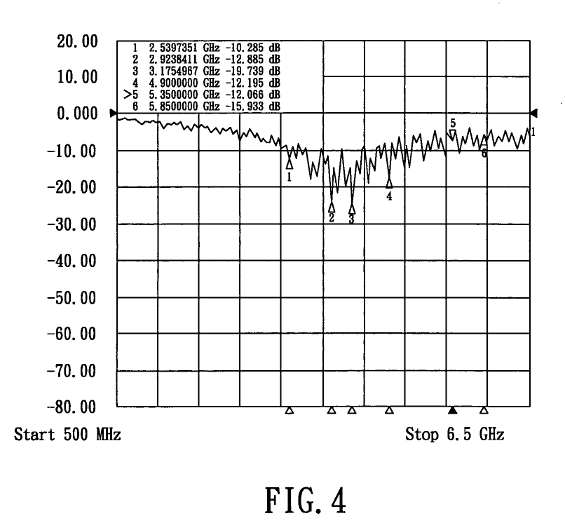

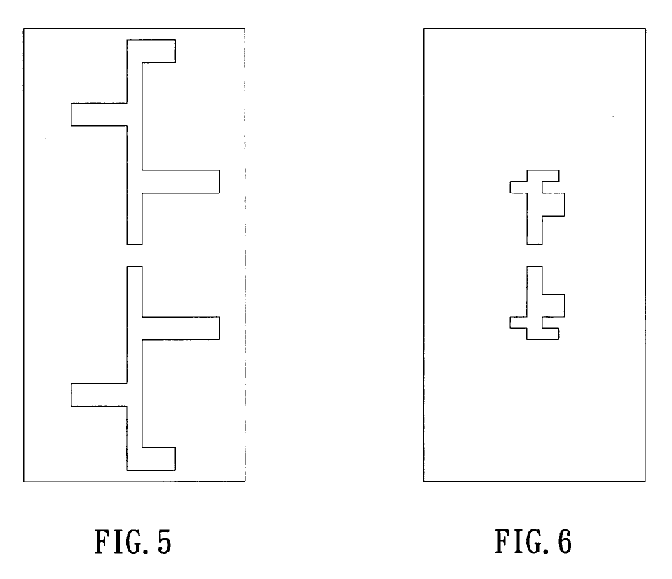

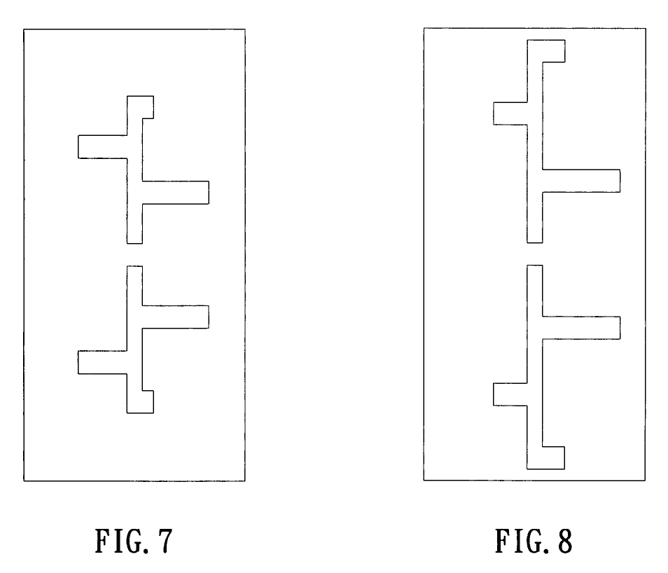

Referring to FIG. 3, it relates to the second embodiment of the asymmetrical yagi representation of dipole UWB antenna. The antenna structure on substrate comprises: a first radiation arm 21, said 21 comprises a first feed point 211, a first branch 212, a second branch 213, and a first tail 214; a second radiation arm 22, said 22 comprises a second feed point 221, a third branch 222, a fourth branch 223, and a second tail 224. Compared with FIG. 1, the most significant different is that in FIG. 3 the first branch 212 of the first radiation arm 21 as well as the third branch 222 of the second radiation arm 22 are longer than those disclosed in FIG. 1. FIG. 4 is the antenna frequency response plot of FIG. 3. Person skilled in the art can understand the minimum value in FIG. 2 is above −20 dB, however; the minimum value in FIG. 4 is below −20 dB. It fully illustrated, after comparing the FIG. 2 and FIG. 4, to change the dimension of any branches or tails of the radiation arms will affect antenna frequency response plot. Also, the disclosures from FIG. 5 to FIG. 10A/B is solely the variation for FIG. 1 in dimension. Its purpose is to cause the different frequency response match to serve the purpose for different electronics demand.

Referring to FIGS. 5, 6, 7 and 8, they further relate to the 3^{rd}, 4^{th}, 5^{th}, and 6^{th} embodiment of the asymmetrical yagi representation of dipole UWB antenna respectively. All kind of variation for them is to change the dimension of the branches and tails of the radiation arm to serve the necessary frequency response.

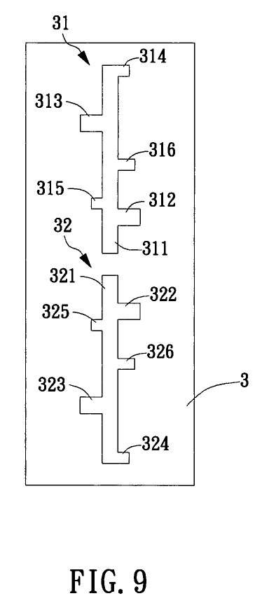

Referring to FIG. 9, it further relates to the 7^{th} embodiment of the asymmetrical yagi representation of dipole UWB antenna, said antenna comprises: a first radiation arm 31, 31comprises a first feed port 311, a first branch 312, a second branch 313 and a first tail 314; a second radiation arm 32, said arm 32 comprises a second feed port 321, a third branch 322, a fourth branch 323 and a second tail 324. Compared with FIG. 1, the key difference is not only the first radiation arm 31 further comprises a fifth branch 315 and a sixth branch 316 between the first branch 312 and the second branch 313 but the second radiation arm 32 also comprises a seventh branch 317 and a eighth branch 318 between the third branch 322 and the fourth branch 323. Said appended branches can lead to different frequency response match in order to serve the electronic product demand.

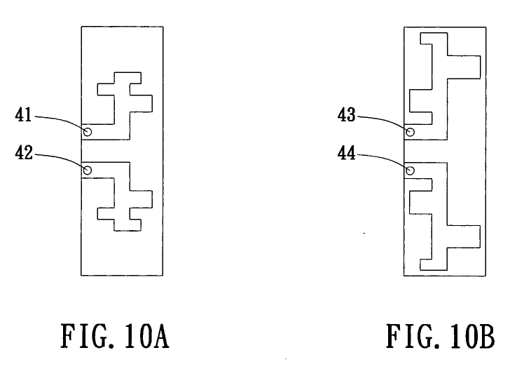

Referring to FIG. 10A/B, they further relates to the 8^{th} and 9^{th} embodiment of the asymmetrical yagi representation of dipole UWB antenna. Compared with these two Figures and FIG. 1, the structural difference for these two figures and FIG. 1 is that a first feed point (41, 43) and a second feed point (42, 44) are both bending to the edge. In addition to obtain a different frequency response match, such a structure can further serve the specific demand of antenna feed points for electronic products.

As suggested by all the figures according to the present invention, it can be understood the present invention, the major purpose of an asymmetrical yagi representation of dipole UWB antenna, is to implement an antenna on a substrate. Said asymmetrical yagi representation of dipole UWB antenna comprises a first radiation arm and a second radiation arm and via the calculation of the number of branches and the dimension of the arms to adjust the desirable frequency response to serve the match purposes. Further more, to implement said antenna on substrate is easy in structure and its yield can be improved. Also, according the actual demand to increase the number of radiation surfaces so that said antenna can transmit and receive multiple different electromagnetic waves according to the different frequencies. This kind of antenna design has high market value so the patent application is launched in order to gain the patent right protection.

It will be appreciated to those skilled in the art having the benefit of the disclosure that this invention is believed to provide a practical implementation of antenna. Further modifications and alternative embodiments of various aspects of the invention will be apparent to those skilled persons in view of this description. The specification and drawings are to be regarded in an illustrative rather than a restrictive sense.

What is claimed is:

1. An asymmetrical yagi representation of dipole UWB antenna, mounted on a substrate and attachable to a wireless communication apparatus, comprising
a first radiation arm, said first radiation arm comprising a first feed point, a first branch, a second branch, and a first tail; and
a second radiation arm, said second radiation arm comprising a second feed point, a third branch, a fourth branch, and a second tail;
wherein said first feed point and said second feed point are interconnected to a wireless communication apparatus, said first tail and said second tail are located at the farthest spot from the first radiation arm and the second radiation arm respectively.

2. The dipole UWB antenna as recited in claim 1, wherein said substrate selected from the group of PCB and metal radiation slice.

3. The dipole UWB antenna as recited in claim 1, wherein said first branch, second branch, third branch, fourth branch, first tail, and second tail are λ/4, said λ is the wavelength corresponding to different frequencies.

4. The dipole UWB antenna as recited in claim 1, wherein said first branch and said second branch, referring to conterminous line of the first feed point, are located at different sides.

5. The dipole UWB antenna as recited in claim 1, wherein said third branch and said fourth branch, referring to conterminous line of the second feed point, are located at different sides.

6. The dipole UWB antenna as recited in claim 1, wherein the dimension of said first branch, said second branch, third branch, fourth branch, first tail and second tail are tunable due to a corresponding frequency response.

7. The dipole UWB antenna as recited in claim 1, wherein a fifth branch and a sixth branch are incorporated into the first radiation arm between said first branch and said second branch.

8. The dipole UWB antenna as recited in claim 1, wherein a seventh branch and a eighth branch are incorporated into the second radiation arm between said third branch and said fourth branch.

9. The dipole UWB antenna as recited in claim 1, wherein said first feed point or said second feed point bending to the edge.
